(19) United States
(12) Patent Application Publication
(10) Pub. No.: US 2025/0162066 A1
(43) Pub. Date: May 22, 2025

(54) METHOD OF AND MACHINE FOR A LASER PROCESSING WITH ROUGHNESS ESTIMATION

(71) Applicants: ADIGE S.P.A., Lavico Terme (IT); POLITECNICO DE MILANO, Milano (IT)

(72) Inventors: Matteo PACHER, Levico Terme (IT); Davide GANDOLFI, Levico Terme (IT); Mara TANELLI, Milano (IT); Barbara PREVITALI, Milano (IT); Sergio Matteo SAVARESI, Milano (IT); Valentina FINAZZI, Milano (IT); Fabio PICCOLI, Milano (IT); Giulio DELAMA, Milano (IT)

(73) Assignees: ADIGE S.P.A., Lavico Terme (IT); POLITECNICO DE MILANO, Milano (IT)

(21) Appl. No.: 18/839,521

(22) PCT Filed: Jun. 26, 2023
(86) PCT No.: PCT/IB2023/056574

§ 371 Date: Aug. 19, 2024

(30) Foreign Application Priority Data
Oct. 25, 2022 (IT) 102022000022038

(51) Int. Cl. B23K 26/03; G06T 7/00; G06T 7/41

(52) U.S. Cl. CPC B23K 26/032; G06T 7/0004; G06T 7/41; G06T 2207/20076; G06T 2207/30164

(57) ABSTRACT

A laser processing method may comprise: a) directing a laser beam onto the work piece at a processing zone of the work piece for executing a laser processing; b) executing a relative movement between the laser beam and the work piece; c) acquiring optical signals, more preferentially a plurality of acquired images, from the processing zone; d) determining a time course of one or more characteristic parameters obtained starting from the optical signals, more preferentially from the plurality of acquired images; e) estimating in dependence of each time course of the one or more characteristic parameters a roughness obtained during the laser processing. During the step e) at least one respective statistical parameter is determined from the time course of the one or more characteristic parameters and afterwards a continuous estimate in real time of the roughness is calculated in function of each determined statistical parameter.

### CROSS-REFERENCE TO RELATED APPLICATIONS

This Patent Application claims priority from Italian Patent Application No. 102022000022038 filed on Oct. 25, 2022, the entire disclosure of which is incorporated herein by reference.

### TECHNICAL FIELD

The present invention relates to a laser processing method, preferentially for cutting and/or drilling and/or welding a work piece and/or executing an additive manufacturing for obtaining a work piece. Preferentially, the present invention relates to a laser processing method which allows estimating, preferentially in real time, a roughness resulting from the laser processing.

The present invention also relates to a laser processing machine configured to execute a laser processing method which allows estimating, preferentially in real time, a roughness resulting from the laser processing.

### BACKGROUND

Laser processing machines are known, for example for cutting and/or drilling work pieces. A typical laser processing machine comprises an emission source of a laser beam, a support for the work piece, an optical group for controlling the focus position of the laser beam and a movement device for executing a relative movement between the laser beam and the work piece.

It is known that the laser processing executed by a laser processing machine, such as for example the cutting of a work piece, can result in the formation of a certain roughness. The roughness which is actually obtained during the laser processing can depend not only on the specific material of the work piece, but also on one or more process parameters such as, for example, the intensity of the laser beam and/or the velocity of the relative movement between the laser beam and the work piece.

To date, the roughness obtained from a laser processing can be determined in laboratory following the termination of the laser processing to then be able to control whether or not the determined roughness corresponds to desired values. Should the roughness not be acceptable, it is necessary for an operator to update one or more process parameters so as to be able to obtain worked pieces having a desired roughness. This means that some treated work pieces do not correspond to the desired criteria and that they are to be discarded or subsequently manually reprocessed.

Therefore, the need is felt in the sector for a further improvement of the laser processing methods and/or of the laser processing machines.

### SUMMARY

The object of the present invention is to provide a laser processing method and a laser processing machine which allow improving the known solutions for obtaining an estimate of the roughness resulting from the laser processing, preferentially in real time.

Preferentially, the object of the present invention is to provide a laser processing method and a laser processing machine which allow obtaining an estimate of the roughness and a control of the method in dependence of the estimated roughness.

The aforementioned objects are achieved by the present invention, as it relates to a laser processing method as defined in the independent claim 1. Alternative preferred embodiments are protected in the respective dependent claims.

The aforementioned objects are also achieved by the present invention, as it relates to a laser processing machine according to claim 15.

### BRIEF DESCRIPTION OF THE DRAWINGS

In order to better understand the present invention, a preferred embodiment thereof is described in the following, by way of non-limiting example and with reference to the accompanying drawings, wherein:

FIG. 1 illustrates in a schematic and partial manner a laser processing machine according to the present invention;

FIG. 2a illustrates an example of an acquired image obtained during the operation of the processing machine of FIG. 1;

FIGS. 2b and 2c illustrate steps of analyzing the acquired image of FIG. 2a;

FIG. 3 illustrates a time course of a characteristic parameter obtained from the analysis of a plurality of acquired images;

FIG. 4 illustrates distributions of the characteristic parameter obtained from the respective time courses of the characteristic parameter during the operation of the processing machine of FIG. 1 in two different conditions; and

FIG. 5 schematically illustrates the method of the present invention.

### DESCRIPTION OF EMBODIMENTS

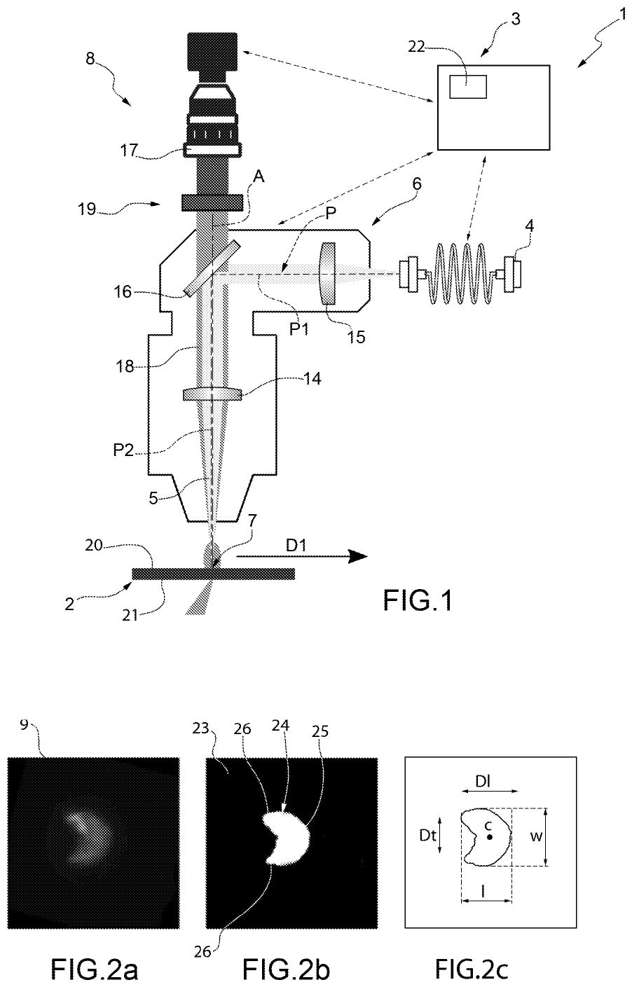

In FIG. 1, reference numeral 1 generically indicates, as a whole, a laser processing machine configured to execute a laser processing on a work piece 2, preferentially to cut and/or drill a work piece 2 and/or to execute a welding and/or to execute an additive manufacturing.

Preferentially, the work piece 2 can comprise and/or be made of a metallic material. For example, the work piece 2 can be made of and/or comprise carbon steel, aluminum or other metals.

It should be noted that the method described in the following was tested by the Applicant relative to work pieces 2 having different compositions and different shapes and as they are usually treated by processing machines of the Applicant. It should be noticed from the very outset that the variety of materials which can be laser processed and the variety of shapes have consequences on the machine learning details, but do not alter the essence of the invention.

According to some non-limiting embodiments, the work piece 2 can have a flat and/or tubular and/or bar shape.

In greater detail, the laser processing machine 1 can comprise:
a control unit 3 for controlling the operation of the laser processing machine 1;
an emission source 4 of a laser beam 5 operatively connected to the control unit 3 and configured to emit the laser beam 5;
an optical group 6, preferentially operatively connected to the control unit 3, configured to control the laser beam 5, preferentially to direct the laser beam 5 along an optical axis A onto the work piece 2 and at a processing zone 7;
a movement device, preferentially operatively connected to the control unit 3 and configured to execute a relative movement between the laser beam 5 and the work piece 2, preferentially at a determined velocity and/or preferentially to define a shape of the cutting and/or of the drilling and/or of the welding and/or of the additive manufacturing.

According to some non-limiting embodiments, the processing zone 7 can be a zone of the work piece 2 which is exposed, in use, to the laser beam 5 and which is consequently processed, for example cut and/or drilled and/or welded and/or additively manufactured. Such processing zone 7 can be, in use, dynamic due to the relative movement between the laser beam 5 and the work piece 2.

Preferentially, the laser processing machine 1 can also comprise:
a generation device (not illustrated and known per se) operatively connected to the control unit 3 and configured to create a jet of gas for directing compounds created during the laser processing, preferentially during the cutting and/or the drilling of the work piece 2, away from the work piece 2.

According to some preferred non-limiting embodiments, the processing machine can also comprise a suction unit configured to remove fumes and/or auxiliary products and/or compounds created during the laser processing.

According to some preferred non-limiting embodiments, the control unit 3 can be configured to control process parameters of the laser processing machine 1, preferentially an intensity of the laser beam 5 and/or a frequency and/or a duty cycle of the pulsed regime of the laser beam 5 and/or a focus position of the laser beam 5 and/or a diameter of the laser beam 5 and/or a determined velocity of the relative movement between the laser beam 5 and the work piece 2 and/or the jet of gas and/or a pressure of the gas of the jet of gas and/or a position of a nozzle configured to emit a jet of gas.

Preferentially, the control unit 3 can be configured to control the process parameters in feedback mode.

It should be noted that preferentially the process parameters can (substantially) be all the parameters defining the operation of the laser processing machine 1.

Advantageously, the laser processing machine 1 can also comprise a monitoring device 8 configured to monitor the process and/or the result of the laser processing. Preferentially, the monitoring device 8 can be configured to monitor the cutting and/or the drilling and/or the welding and/or the additive process of the work piece 2.

Preferentially, the monitoring device 8 can be configured to acquire signals, preferentially optical signals.

In the specific illustrated case, the monitoring device 8 is configured to acquire a plurality of acquired images 9 (an exemplifying acquired image is illustrated in FIG. 2a), preferentially of the processing zone 7.

Preferentially, the monitoring device 8 is configured to acquire the optical signals, preferentially the acquired images 9, continuously and in real time during the laser processing.

Alternatively, the monitoring device 8 can comprise an interferometer, as for example described in EP-A-3832251, WO-A-2021111393 or WO-A-2021111399.

Preferentially, the monitoring device 8 can be operatively connected to the control unit 3, which can be configured to control the operation of the laser processing machine 1 at least in function of information extracted and/or obtained from the monitoring device 8, preferentially starting from the acquired signals, more preferentially from the acquired optical signals, even more preferentially starting from the acquired images 9.

Preferentially, the monitoring device 8 can be configured to acquire the signals, preferentially the optical signals, more preferentially the acquired images 9, during the operation of the laser processing machine 1 (in other words, the monitoring device 8 can be configured to operate in an on-line manner and in real time).

According to some preferred non-limiting embodiments, the monitoring device 8 can be configured to acquire the process emission, i.e. the heat thermal emission, preferentially present at the processing zone 7. Alternatively, the monitoring device 8 can be configured to acquire an electromagnetic radiation (light) resulting from a lighting by means of a separate lighting source.

Preferentially, the emission source 4 can comprise a laser, for example an ND:YAG laser, a laser of the fiber type, a carbon dioxide laser or a diode laser. For example, the laser can be a laser which emits a laser beam 5 with a wavelength λ of 1070 nm at a power of 6 kW.

In greater detail, the optical group 6 can be configured to direct the laser beam 5 onto the work piece 2 and determine the focus of the laser beam 5.

Preferentially, the optical group 6 can be configured to define an optical path P from the emission source 4 towards the work piece 2.

According to some non-limiting embodiments, the optical path P can comprise a first portion P1 transversal, more specifically perpendicular, to the optical axis A and/or a second portion P2 coaxial to the optical axis A.

In other words, the laser beam 5 propagates along the portion P1 and the portion P2 respectively, with P1 being transversal to P2, preferentially the direction P2 coincides with the optical axis A.

Alternatively, the path P could be coaxial to the optical axis A.

According to some preferred embodiments, the optical group 6 can comprise at least one focus lens 14 configured to determine the focus of the laser beam 5; preferentially the focus lens 14 can be arranged in the portion P2.

Preferentially, the optical group 6 can also comprise a collimation lens 15 and a dichroic mirror 16 configured to deviate the laser beam 5 from the portion P1 to the portion P2. In particular, the collimation lens 15 can be arranged in the portion P1.

Alternatively, the dichroic mirror 16 can be configured to deviate the optical axis A and leave the path P of the laser beam 5 unaltered.

In greater detail, the movement device can be configured to control a movement of the laser beam 5 relative to the work piece 2 in a first relative advancement direction D1 and/or in a relative second advancement direction transversal, preferentially perpendicular, to the first relative advancement direction D1.

According to some preferred embodiments, the movement device can comprise a support (not illustrated and known per se) configured to support the work piece 2. According to some non-limiting variations, the support can be movable so as to be set into movement for obtaining a relative movement between the laser beam 5 and the work piece 2.

Alternatively or additionally, at least one portion of the movement device can be integrated in and/or associated with the support for moving the work piece 2 so as to obtain a relative movement between the laser beam 5 and the work piece 2.

Alternatively or additionally, the movement device can comprise a movable supporting base carrying the emission source 4 and/or the optical group 6 and/or a portion of the optical group 6 for moving the laser beam 5.

In greater detail, the monitoring device 8 can comprise at least one sensor, preferentially an optical sensor, configured to acquire the signals, preferentially the optical signals, more preferentially to acquire the acquired images 9.

Preferentially, the sensor can be and/or comprise a video camera 17, for example of the CCD or CMOS type, configured to acquire the signals, preferentially the optical signals, more preferentially the acquired images 9.

More specifically, the video camera 17 can be configured to acquire the acquired images 9 continuously and in real time, so as to obtain a time sequence of the acquired images 9.

More preferentially, the video camera 17 can be configured to acquire the acquired images 9 at a frequency of at least 1000 frames per second, even more preferentially at least 1500 frames per second.

For example, the video camera 17 can be an XiQ MQ013MG-ON, Ximea, Münster, Germany, preferentially associated with an infrared filter.

The video camera 17 can have, for example, a resolution of 200×200 pixels and can operate at 750 Hz.

Preferentially, the video camera 17 can be configured to acquire an electromagnetic radiation beam 18 originating from the processing zone 7.

According to some preferred non-limiting embodiments, the electromagnetic radiation beam 18 can correspond to the process emissions at the processing zone 7. According to such an embodiment, the need for an additional lighting source is prevented.

Alternatively, the electromagnetic radiation beam 18 can result from a lighting of the processing zone 7, for example by means of a separate lighting source.

Preferentially, the electromagnetic radiation beam 18 can pass through at least one portion of the optical group 6, in particular the focus lens 14 and the dichroic mirror 16.

According to some non-limiting embodiments, the optical sensor, preferentially the video camera 17, can be arranged coaxial to the optical axis A. More preferentially, the electromagnetic radiation beam 18 can propagate, in use, parallel to at least the portion P2.

Alternatively, the electromagnetic radiation beam 18 could propagate along a path having at least two portions transversal to each other.

In greater detail, the monitoring device 8 can also comprise an optical filtering group 19 configured to guarantee that the optical sensor, preferentially the video camera 17, receives, in use, the electromagnetic radiation in a defined wavelength band. Preferentially, the optical filtering group 19 can operate in the near infrared (being a filter in the near infrared).

Preferentially, the optical filtering group 19 can be arranged upstream of the video camera 17 relative to the third direction.

As is described in greater detail in the following, the control unit 3 can be configured to control the operation of the laser processing machine 1.

For example, the laser beam 5 can incise, preferentially by means of heating, the material from the work piece 2 at the processing zone 7 creating a slit which extends along the entire thickness of the work piece 2. Such slit has and/or is delimited by a surface having a roughness determined by the laser processing.

It should be noted that the roughness can be expressed in various manners. For example, the roughness can be described in terms of an arithmetic mean roughness (known in the sector as Rₐ), i.e. of an arithmetic mean value of a roughness profile determined by deviations with respect to a central line within an evaluation extension. Another manner can be to describe the roughness relative to a peak maximum height downstream of the roughness profile and the determination of a mean value on the extension of the evaluation of the roughness profile (such roughness is known in the sector as R_{z}). Still further manners for defining the roughness are known which, however, are well known to the person skilled in the art.

However, it should be highlighted that, for the object of the present invention, the specific choice of the roughness is not relevant, but only has to then be utilized coherently during the machine learning processes.

In greater detail, the laser beam 5 can incise the work piece 2 from a first surface 20 of the work piece 2 to a second surface 21 of the work piece 2 opposite the first surface 20. Even more in particular, during the laser processing a surface transversal to the first surface 20 and to the second surface 21 is formed, said transversal surface having a roughness determined by the laser processing.

Preferentially, the control unit 3 can comprise an analysis module 22 configured to analyze the acquired signals, preferentially the acquired optical signals, more preferentially the acquired images 9.

As is explained in greater detail in the following, the analysis module 22 can be configured to estimate a roughness (i.e. an estimated value of the roughness) resulting from the laser processing, for example resulting from a cutting action.

Preferentially, the analysis module 22 can be configured to associate a time information (i.e. a time moment of the estimate) and/or a space information (i.e. a position of the laser processing with which the estimate of the roughness is associated) with each estimated roughness.

Preferentially, the control unit 3 can be configured to control and/or modify, preferentially in feedback, one or more process parameters in dependence of the roughness estimated by the analysis module 22, preferentially for obtaining a desired roughness.

For example, should the estimated roughness be less than the desired roughness, the control unit 3 can be configured to increase the determined velocity of the relative movement between the laser beam 5 and the work piece 2; or should the estimated roughness be greater than the desired roughness, the control unit 3 can be configured to decrease the determined velocity of the relative movement between the laser beam 5 and the work piece 2.

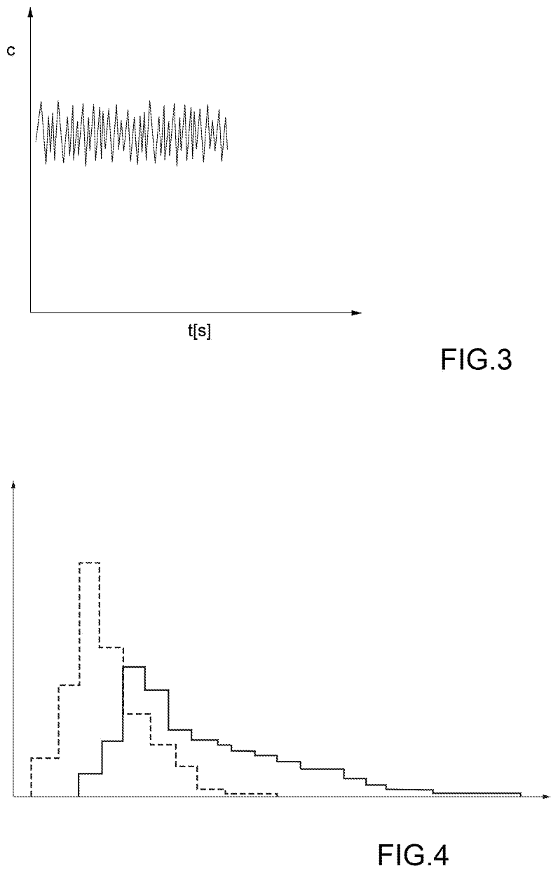

However, the control unit 3 can also be configured to modify other process parameters. Preferentially, the analysis module 22 can be configured to determine, preferentially in real time, a time course of at least one characteristic parameter (see FIGS. 2c and 3), preferentially respective time courses of a plurality of characteristic parameters, obtained starting from the acquired signals, preferentially from the acquired optical signals, more preferentially from the acquired images 9.

Preferentially, the analysis module 22 can also be configured to calculate at least one statistical parameter, preferentially a plurality of statistical parameters, from the respective time courses of the characteristic parameter or parameters and to estimate the roughness starting from the statistical parameter or parameters. Preferentially, each time course can be considered for a defined time, in particular this defined time can be constant.

In greater detail, the analysis module 22 can be configured to transform each acquired image 9 (regardless of the others) into a transformed image 23 (see FIG. 2b), in particular by means of a segmentation so as to obtain a respective binary image. Preferentially, each transformed image 23 (binary image) comprises a first color (for example, white) and a second color (for example, black).

It should be considered that each acquired image 9 can have information relative to the acquired intensities, for example correspond to the intensities of the process emissions. In particular, the first color and the second color are associated with the respective zones of each transformed image 23 which have intensities that are respectively less or greater than or equal to a determined intensity threshold.

According to some preferred embodiments, each acquired image 9 and consequently the respective transformed images 23 comprise a respective high intensity zone 24.

Preferentially, each high intensity zone 24 can comprise a respective main portion 25, for example can be approximated and/or described by means of a circular or elliptical shape, and one or more respective elongated portions 26 extending from the respective main portion 25.

Preferentially, each high intensity zone 24 is defined, and preferentially also the respective main portions 25 and/or the respective elongated portions 26 are defined, based on the zones of the respective acquired image 9 which have intensities that are greater than or equal to the determined intensity threshold.

With particular reference to FIG. 2c, each of the aforementioned characteristic parameters can correspond to a geometrical parameter of the high intensity zone 24.

For example, each geometrical parameter can be chosen from the group consisting of: a surface area of the high intensity zone 24, a center of mass c of the high intensity zone 24, a width w of the high intensity zone 24, a length l of the high intensity zone 24, other form factors of the high intensity zone 24 and/or their combinations.

In greater detail, each high intensity zone 24 can extend in a longitudinal direction Dl and a transversal direction Dt transversal, preferentially perpendicular, to the longitudinal direction Dl.

For example, the respective width w can be defined by a maximal extension of the high intensity zone 24 in the transversal direction Dt.

For example, the respective length l of each high intensity zone 24 can be defined by a maximal extension of the high intensity zone 24 in the longitudinal direction Dl.

It should be noted that each characteristic parameter can be defined not only by the geometrical characteristics, but also by their combinations and/or by respective time derivatives.

For example, the surface area of the high intensity zone 24 can correspond to the number of pixels which have an intensity equal to or greater than the determined intensity threshold. Preferentially, the surface area can be determined by the respective binary image.

It should be noted that according to some embodiments it is possible to generate more than one binary image of each acquired image 9, each binary image being generated in consideration of a different intensity threshold. In other words, it could be possible to consider a plurality of surface areas as characteristic parameters which are distinguished from the specific intensity threshold applied.

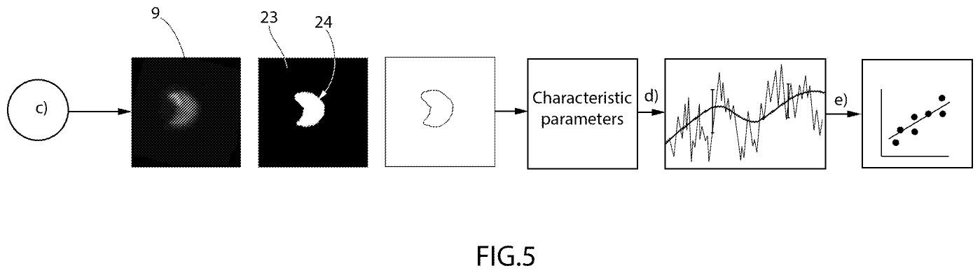

According to some preferred embodiments, the analysis module 22 can also be configured to determine a respective probabilistic distribution (see FIG. 4) from the respective time course of each characteristic parameter and to determine the statistical parameter or parameters from the respective probabilistic distribution.

Preferentially, the respective statistical parameters are chosen from the group consisting of a respective mean value, a respective variance and a statistical moment of higher order.

Preferentially, FIG. 4 illustrates two schematic examples of probabilistic distributions relative to two conditions of a cutting action which are distinguished, for example, for a variation of at least one process parameter, such as the velocity of the relative movement between the laser beam 5 and the work piece 2. In dependence of these probabilistic distributions, it is possible to estimate two different roughnesses.

Preferentially, the analysis module 22 can be configured to operate in continuous mode, preferentially in time and/or in quantity, in such a manner so as to determine a time course of the estimate of the roughness.

Advantageously, the analysis module 22 can be configured to calculate a continuous estimate in real time of the roughness in function of each characteristic parameter, preferentially of each determined statistical parameter.

In greater detail, the analysis module 22 can be configured to estimate the roughness by means of a statistical regression in dependence of the statistical parameter or parameters determined for estimating the roughness.

In particular, the statistical regression model was trained according to standard machine learning methods.

More specifically, the analysis module 22 can estimate the roughness by means of a linear or nonlinear regression model or a decision tree regression or a random forest regression or an Extreme Gradient Boosting regression or a linear probability model regression or a multilayer perception regression in function of each statistical parameter.

Alternatively or additionally, the analysis module 22 can be configured to execute a classification in classes in dependence of the statistical parameter or parameters determined for estimating the roughness.

The Applicant found that all the statistical regression models tested have good and very satisfactory estimates of the roughness. Furthermore, the tests by the Applicant highlighted that none of the statistical regression models can be considered superior to the other statistical regression models in estimating roughness (in consideration of various factors, which can be the performance of the model, its easiness of application, etc.).

For example, the linear regression model can be easily integrated, but has a performance slightly inferior to the multilayer perception regression model.

According to some embodiments, the control unit 3 can also be configured to receive and/or allow the definition and/or a modification of a desired roughness, for example by means of a human-machine interface of the laser processing machine 1 and/or of the control unit 3. For example, the desired roughness can be expressed in terms of a desired mean value of the roughness.

Preferentially, the control unit 3 can be configured to control the process parameters in function of the estimate of the roughness and of the desired roughness.

In use, the laser processing machine 1 executes a laser processing of a work piece 2, for example for cutting and/or drilling and/or welding and/or producing in an adaptive manner the work piece 2.

Advantageously, the laser processing method, preferentially executed by the laser processing machine 1, comprises at least the following steps:
a) directing, preferentially thanks to the emission source 4 and to the optical group 6, the laser beam 5 onto the work piece 2, preferentially at the processing zone 7 of the work piece 2 and/or for executing a laser processing, for example for executing a cutting and/or a drilling and/or a welding operation and/or an additive manufacturing, of the work piece 2; and
b) executing, preferentially by means of the movement device, the relative movement between the laser beam 5 and the work piece 2, preferentially at a determined velocity, and preferentially for defining the shape of the cut and/or of the hole.

Advantageously, the method can also provide for monitoring, preferentially in real time and continuously, the laser processing, preferentially the result of the laser processing, for estimating the roughness resulting from the laser processing.

The executing of the method in real time and continuously means that the method is executed during the entire laser processing (i.e. during the entire time path of the laser processing) and it is possible to intervene (if necessary) during the laser processing and not only following the laser processing.

In other words, and as is explained in greater detail in the following, according to the present invention an estimate of the roughness is obtained during the executing of the laser processing and substantially during every moment of the laser processing.

For this reason, the method can also comprise the following steps (see FIG. 5):
c) acquiring signals, preferentially optical signals, more preferentially a plurality of acquired images 9, of the processing zone 7;
d) determining a time course (see for example FIGS. 3 and 5) of one or more characteristic parameters obtained starting from the signals, preferentially from the optical signals, more preferentially from the plurality of acquired images 9;
e) estimating in dependence of each time course of the one or more characteristic parameters a roughness (i.e. a respective estimated value of the roughness) obtained during the laser processing.

Preferentially, the steps from c) to e) can be executed by the analysis module 22.

Preferentially, the steps from c) to e) can be executed continuously and in real time. In other words, the optical signals, preferentially the acquired images 9, can be acquired and analyzed during the executing of the laser processing and for obtaining the estimates of the roughness during the laser processing.

According to some preferred embodiments, during the step d) the time courses of at least two characteristic parameters, preferentially at least three characteristic parameters can be determined, and during the step e) the roughness is estimated in dependence of each determined time course. In particular, during the step e) one or more statistical parameters of each time course are determined and during the step e) the roughness is estimated in dependence of each statistical parameter.

The Applicant observed that in this manner it is possible to improve the quality of the estimate of the roughness.

According to some non-limiting embodiments, during the step e) time and/or space information can be associated with each estimate of the roughnesses (i.e. with each estimated value of the roughness).

More specifically, each space information can result from the correlation between the time information of each roughness estimate and the relative movement (for example characterized by the velocity and/or the advancement direction or directions) between the laser beam 5 and the work piece 2.

In greater detail and with particular reference to FIGS. 3 to 5, during the step e) at least one respective statistical parameter can be determined from the time course of the one or more characteristic parameters and afterwards a continuous estimate in real time of the roughness can be calculated in function of the at least one determined statistical parameter.

It should be noted that the term “continuous in real time” means that the estimate of the roughness is executed during the laser processing.

According to some variations, during the step e) a plurality of statistical parameters can be determined from the time course of at least one characteristic parameter and/or of a plurality of characteristic parameters. For example, it is possible that two statistical parameters are determined from the time course of a first characteristic parameter, whereas one single statistical parameter is determined from the time course of a second characteristic parameter.

According to some preferred non-limiting embodiments, during the step e) a respective probabilistic distribution can be determined from the at least one time course of the characteristic parameter or parameters.

Preferentially, each statistical parameter can be determined from at least one respective probabilistic distribution.

For example, statistical parameters can be determined such as a respective mean value, a respective variance or a statistical moment of higher order (from the respective probabilistic distribution).

In further detail, during the step e) a statistical regression is executed in dependence of the determined statistical parameter or parameters for estimating the roughness. For example, during the step e) it is possible to employ a linear or nonlinear regression model or a decision tree regression or a random forest regression or an Extreme Gradient Boosting regression or a linear probability model regression in function of each statistical parameter for obtaining an estimate of the roughness.

Alternatively or additionally, during the step e) a classification in classes can be executed in dependence of the statistical parameter or parameters determined for estimating the roughness.

In particular, the mentioned algorithms correspond to standard machine learning algorithms.

As already aforementioned, in dependence of the specific chosen roughness (for example Rₐ or R_{z}) the algorithms are trained according to the standards known to the person skilled in the art.

According to some preferred embodiments, during the step c) a plurality of acquired images 9 of the processing zone 7 can be acquired, preferentially continuously and in real time, preferentially each acquired image 9 can be acquired in a time moment different from the other ones. In other words, during the step c) a time sequence of acquired images 9 can be determined.

Preferentially, the time course of each characteristic parameter can be determined from the respective high intensity zones 24. Furthermore, the time course of each characteristic parameter derives from the fact that each acquired image 9 was acquired in a different time moment. Furthermore, but not necessarily, according to such an embodiment, the time and/or space information of the roughness estimates can also be determined.

Preferentially, each characteristic parameter can correspond to a geometrical parameter of the high intensity zone 24.

For example, the geometrical parameter can be chosen from the group consisting of: a surface area of the high intensity zone 24, a center of mass c of the high intensity zone 24, a width of the high intensity zone, a length of the high intensity zone, other form factors of the high intensity zone and/or their combinations.

The Applicant observed that the choice to use at least the center of mass c of the high intensity zone 24 as characteristic parameter allows an accurate estimate of the roughness. Preferentially, also one or more other characteristic parameters are chosen, such as in particular the surface area, for obtaining a further improvement of the estimate.

According to some preferred non-limiting embodiments, the method further comprises a step f) of controlling, during which one or more process parameters are controlled in function of the estimated roughness. Preferentially, during the step f) the one or more process parameters are controlled so as to obtain a desired roughness.

It should be noted that the desired roughness can be expressed in terms of a desired mean value of the roughness. According to some possible variations, the desired roughness (i.e. the respective desired mean value) can comprise a defined range within which the estimated roughness has to fall.

It should be highlighted that the desired roughness can be described relative to one of the known types of roughness such as, for example, Rₐ and R_{z} provided that the use during the executing of the method is coherent; i.e. the desired roughness can refer, for example, to the roughness Rₐ and, therefore, also the estimated roughness will refer to the estimated roughness Rₐ.

Preferentially, during the step f), the control unit 3 compares the estimated roughness with the desired roughness. The control unit 3 maintains the process parameters constant if the estimated roughness corresponds to the desired roughness and varies one or more process parameters if the estimated roughness does not correspond to the desired roughness.

According to some preferred non-limiting embodiments, the steps from a) to e), preferentially the steps from a) to f), are executed continuously in time, and preferentially so as to obtain a desired work piece 2. In other words, a control of the method is obtained during the laser processing. Furthermore, it is possible to intervene should the estimated value of the roughness not correspond to the value of the desired roughness.

According to some preferred non-limiting embodiments, the method further comprises a step g) of repetition, during which the steps from a) to e), preferentially the steps from a) to f) are repeated, in particular for executing the method continuously and preferentially in real time.

According to some preferred non-limiting embodiments, the steps from c) to e), preferentially the steps from c) to f), are executed during the executing of the steps a) and b). This means that the steps from c) to e), preferentially the steps from c) to f), are executed during the laser processing (and not subsequently to it).

According to some preferred non-limiting embodiments, also a step of storing can be executed, during which the values of the roughness estimates are stored, for example in a memory of the laser processing machine 1. Preferentially, the values of the roughness estimates can be stored together with time and/or space information (i.e. each value can be ascribed to a certain time moment of the respective estimate of the value and/or of the position relative to the laser processing).

Preferentially the step of storing can be executed automatically by the analysis module 22.

According to some preferred non-limiting embodiments, a step of generating can also be executed, during which a documentation is generated from the values of the roughness estimates, preferentially from the values of the roughness estimates stored during the step of storing.

Preferentially, the documentation can be utilized for certification purposes of the laser processing. For example, by means of the documentation it can be possible to demonstrate that the roughness obtained during the laser processing corresponds to the desired values according to defined qualitative standards.

Preferentially, the step of generating can be executed automatically by the analysis module 22.

According to some preferred embodiments, during the step d), the time course of each characteristic parameter can be determined for a defined time, in particular defined and constant (in other words, the number of acquired images 9 which can be utilized for determining each characteristic parameter is constant and predefined).

Therefore, each roughness estimate is based on the analysis of a defined number of acquired images 9.

In greater detail, each acquired image 9 was acquired at a specific time t. Consequently, it is possible to extract the chosen characteristic parameter and associate the respective time t with each characteristic parameter. Subsequently, it is possible to obtain a time course of the characteristic parameter, as is illustrated in FIG. 3. The statistical analysis of this time course allows determining the respective statistical parameter or parameters.

In further detail, during the step c), the analysis module 22 can operate in continuous mode, preferentially both in time and in quantity, so as to determine the time course of the characteristic parameter or parameters.

More specifically, during the step d) the analysis module 22 analyzes for each characteristic parameter a plurality of acquired images 9, acquired in succession to each other and during the defined time. These acquired images 9 then allow estimating the roughness and for different time moments.

For example, the analysis module 22 analyzes a first plurality of acquired images 9 and a second plurality of acquired images 9 for respectively determining a first roughness estimate and a second roughness estimate subsequent in time to the first roughness estimate. Furthermore, the analysis can provide for the first plurality of acquired images 9 and the second plurality of acquired images 9 to partially overlap for obtaining the respective roughness estimates.

Preferentially, the second plurality of acquired images 9 comprises the same number of acquired images 9 of the first plurality of acquired images 9. The second plurality of acquired images 9 comprises a defined number of additional acquired images 9 which were acquired (relative to the time course) after the acquired images 9 of the first plurality of acquired images 9 (in other words, the defined number of acquired images 9 follow, relative to the time course, the last acquired image 9 of the first plurality of acquired images 9).

In other words, the first plurality of acquired images 9 and the second plurality of acquired images 9 cover an identical period of time, in particular equal to the defined time. Whereas, the sequence of the first plurality of acquired images 9 comprises acquired images 9 which were acquired before all the other ones, the second plurality of acquired images 9 comprises a sequence of acquired images 9 of which at least one acquired image 9 was acquired after all the other ones of the first plurality.

This process is repeated and the second plurality of acquired images 9 takes on the role of the first plurality of acquired images 9.

Preferentially, during the step d), a sub-step of transforming can be executed, during which each acquired image 9 is transformed into a respective transformed image 23. After which, each characteristic parameter can be obtained from the transformed image 23.

In particular, the sub-step of transforming can define and/or be a sub-step of “thresholding” during which each acquired image 9 is segmented for obtaining a respective binary image (transformed image 23).

Preferentially and with particular reference to FIG. 2b, during the sub-step of “thresholding” the following can be associated: the first color (for example, white) with respective zones of each transformed image 23 (binary image) which correspond to respective zones of the respective acquired image 9 which have intensities that are equal to or greater than the determined intensity threshold; and the second color (for example, black) with respective zones of each transformed image 23 (binary image) which correspond to respective zones of the respective acquired image 9 which have intensities that are below the determined intensity threshold.

In greater detail, during the sub-step of “thresholding”, each pixel of the respective acquired image 9 can be associated with the first color or the second color for obtaining the respective transformed image 23 based on the determined intensity threshold. The first color can be associated with the pixels that have an intensity equal to or greater than the determined intensity threshold and the second color can be associated with the pixels that have an intensity below the determined intensity threshold.

By examining the characteristics of the laser processing machine 1 and of the method according to the present invention, the advantages that they allow obtaining are evident.

In particular, it is possible to obtain an estimate of the roughness during the laser processing and not only afterwards.

Furthermore, it is possible to estimate the roughness continuously in time and during the laser processing.

It is also possible to control the process parameters so as to modify them for obtaining a desired roughness. This allows preventing the need for a reprocessing of the finished work piece 2 and/or obtaining an optimization of the productivity of the laser processing.

Finally, it is clear that modifications and variations can be made to the laser processing machine 1 and to the method described and illustrated herein which do not depart from the scope of protection defined by the claims.

1. A laser processing method of a work piece of a metallic material for cutting and/or drilling, comprising at least the steps of:
a) directing a laser beam onto the work piece at a processing zone of the work piece for executing a laser processing;
b) executing a relative movement between the laser beam (5) and the work piece;
c) acquiring a plurality of acquired images, from the processing zone, each acquired image comprising a high intensity zone;
d) determining from the respective high intensity zones of the plurality of acquired images a time course of one or more characteristic parameters; and
e) estimating in dependence of each time course of the one or more characteristic parameters a roughness obtained during the laser processing;
wherein during the step e) at least one respective statistical parameter is determined from the time course of the one or more characteristic parameters and the roughness is estimated in dependence of the at least one statistical parameter.

2. Method according to claim 1, wherein during the step e) at least one respective probabilistic distribution is determined from one or more time courses of the one or more characteristic parameters.

3. Method according to claim 1, wherein during the step e) a statistical regression is executed and/or a classification in classes is executed in dependence of the determined statistical parameter or parameters for estimating the roughness.

4. Method according to claim 3, wherein during the step e) a linear or nonlinear regression model or a decision tree regression or a random forest regression or an Extreme Gradient Boosting regression or a linear probability model regression or a multilayer perceptron regression is employed in function of each statistical parameter for obtaining an estimate of the roughness.

5. (canceled)

6. Method according to claim 17, wherein the geometrical parameter is chosen from the group consisting of: a surface area of the high intensity zone, a center of mass of the high intensity zone, a width of the high intensity zone, a length of the high intensity zone, other form factors of the high intensity zone and/or their combinations.

7. Method according to claim 6, wherein during the step e) at least one respective probabilistic distribution is determined from one or more time courses of the one or more characteristic parameters and each statistical parameter is chosen from the group consisting of a respective mean value, a respective variance, and a statistical moment of higher order of the respective probabilistic distribution.

8. Method according to claim 17, wherein each high intensity zone is defined based on the zones of the respective acquired image which have intensities that are greater than or equal to a determined intensity threshold.

9. Method according to claim 8, wherein during the step d) the time courses of at least two characteristic parameters, preferentially of at least three characteristic parameters are determined, and during the step e) one or more statistical parameters are determined from each determined time course and the roughness is estimated in dependence of each statistical parameter.

10. Method according to claim 9, wherein the steps from a) to e) are continuously executed and/or wherein the steps from c) to e) are executed during the executing of steps a) and b).

11. Method according to claim 1, further comprising a step of controlling, during which one or more process parameters are controlled in function of the estimated roughness.

12. Method according to claim 11, wherein during the step of controlling, the process parameter or the process parameters are controlled such to obtain a desired roughness.

13. Method according to claim 1, further comprising a step of generating, during which a documentation, preferentially a documentation for certification purposes, is generated from the values of the roughness estimates.

14. Method according to claim 1, wherein during the step d), the time course is determined for a defined time, preferentially the defined time being constant.

15. Laser processing machine comprising:
a control unit for controlling the operation of the laser processing machine;
an emission source operatively connected to the control unit and configured to emit a laser beam;
an optical group for controlling the laser beam; and
a movement device operatively connected to the control unit and configured to execute a relative movement between the laser beam and the work piece;
wherein the control unit is configured and/or programmed to control the emission source and/or the optical group and/or the movement device in such a manner so as to execute a method according to claim 1.

16. Method according to claim 1, wherein a time course of the estimate of the roughness is determined in function of the at least one determined statistical parameter; and/or a continuous estimate in real time of the roughness is calculated in function of each determined statistical parameter.

17. Method according to claim 1, wherein each characteristic parameter corresponds to a geometrical parameter of the high intensity zone.
